(19) United States
(12) Patent Application Publication
(10) Pub. No.: US 2002/0166421 A1
(43) Pub. Date: Nov. 14, 2002

(54) Screw driving, locking and alignment device

(76) Inventor: Jeffrey Allen Bowerman, Bailey, CO (US)

Correspondence Address: HANES & SCHUTZ, PC, 7222 COMMERCE CENTER DRIVE, SUITE 243, COLORADO SPRINGS, CO, 80919

(21) Appl. No.: 09/854,385

(22) Filed: May 11, 2001

(51) Int. Cl. B25B 23/08

(52) U.S. Cl. 81/451

(57) ABSTRACT

Apparatus for locking a fastening screw to a screw-driving tool and simultaneously aligning the screw with the axis of rotation of the tool is disclosed. The apparatus is at attachment, adapted for mounting on the shank of a screw-driving tool that includes a driving bit to engage the slot, slots or other bit-receiving device in the head of the screw. The mouth of the attachment receives at least the head of the screw, permitting the screw head to engage the driving bit. A selectively operable locking sleeve, when properly positioned, forces one or more tumblers into locking engagement with the screw, maintaining the screw in a position of longitudinal alignment with the axis of the shank of the screw-driving tool. The apparatus may also contain a locking stop that interacts with the shank of the screw driver to provide locked engagement between the driving bit and the screw head to prevent partial or complete disengagement of the bit and the screw head during the driving operation.

### FIELD OF INVENTION

The present invention relates to an attachment for hand tools that are used to drive and seat screw type fasteners. The driver may be a manually operated traditional screwdriver with a shank and a bit, or it may be a power operated drill whose chuck holds a shank having a screw driving bit at the end thereof.

### BACKGROUND

Devices for holding screw fasteners to the driving device date back at least to 1907 when U.S. Pat. No. 772,912 issued to H. V. Allam for Screw Holding Attachment for Screw Drivers. Since then, many other patents have been issued for similar devices including, U.S. Pat. No. 2,235,235 to Price, U.S. Pat. No. 3,739,825 to Knox, U.S. Pat. No. 3,884,282 to Dobrosielski and U.S. Pat. No. 4,736,658 to Jore. The later patent discloses a retaining sleeve that can be selectively positioned on the screwdriver shank to loosely encompass the screw while it is being driven in order to keep the screw in touch with the driver bit and not allow it to fall away from the driving tool. A magnetized screw bit assists in keeping the screw attached to the bit until the driving operation is under way.

While devices similar to the Jore holding attachment may hold a screw magnetically bound to the driver bit, there is nothing to keep the longitudinal axis of the screw aligned with the screwdriver's axis of rotation. In other words, the screw will lean angularly against the side wall of the slip collar. This requires the craftsman to hand position the screw in proper alignment with the axis of the driving device and then hold it in such position until it gets well started into the material into which it is being driven. The use of a second hand to hold the screw straight is tedious and may be impossible in difficult situations where, for example, the operator is applying the screw to an overhead structure where a one arm stretch with the driving tool is required to reach the screw target. Placing screws in material at an angle is another operation that makes hand alignment of the screw a difficult, frustrating and sometimes time-consuming task.

Another unsolved problem with prior art screw holding devices is that none of them provide a locking attachment between the screw and the driving bit. Especially with an electrically powered screwdriver, the bit may become partially disengaged from the slot in the screw head resulting in the bit turning on top of the screw head, chewing up the screw head slots and damaging the bit.

It is therefore the primary object of the present invention to solve the problems associated with prior art screw holding and driving devices by providing an attachment for screw driving devices that lock the driving bit into the screw head while simultaneously maintaining the axis of the screw in alignment with the axis of rotation of the screwdriver shank.

It is also an object of the invention to provide an attachment for the shank of a hand or power operated screw-driving tool that will lock a screw into its engagement with the driving bit during the driving operation and will release the screw when the driving operation is complete.

Another object of the invention is to provide a locking device that will insure that the driving bit remains seated in the slot, slots or other bit receptacle in the head of the screw, to avoid stripping out the screw head or damaging the driving bit.

A further fundamental object of the invention is to provide a screw holding device that rigidly maintains the screw in alignment with the axis of rotation of the shank of the screwdriver during the driving process Another object of the invention is to provide a screw holding and driving device that enables a craftsman to precisely place the point of a screw on the target point with only the driving device.

A still further object of the invention is to provide a screw driving device that will drive a screw without holding or positioning assistance from means other than the driver itself, even if the screw is to be driven into resistant material at a steep angle.

Other objects, features and advantages of the invention will become apparent upon a reading of the following detailed descriptions of the invention, taken in conjunction with the drawings.

### SUMMARY OF THE INVENTION

The apparatus for locking a fastening screw to a screw-driving tool, that includes a shank and an attached driving bit, and simultaneously aligning the screw with the axis of rotation of the tool comprises a base member that is slidably mounted on the shank of the tool and a locking latch that is mounted on the base member. The base member also carries at least one locking tumbler that is activated to a locking posture by the selectively operable locking latch. When properly positioned, the latch forces the one or more tumblers into locking engagement with the screw, allowing the screw to rotate for the driving operation, but maintaining the screw in a position of longitudinal alignment with the axis of the shank of the screw-driving tool. When the screw-driving operation is near completion the locking latch is retracted or withdrawn, relieving the restraining force on the tumblers and unlocking the screw, allowing it to be completely seated in the material in which it is being driven. Preferably, the apparatus also includes a locking stop that interacts with the shank of the screw driving tool to provide locked engagement between the driving bit of the shank and the screw head to prevent partial or complete disengagement of the bit and the screw head during the driving operation.

### DESCRIPTION OF THE DRAWINGS

FIG. 1 is a perspective view of the screw alignment and locking device of the present invention.

FIG. 2 is a side view of a typical cordless drill holding the shank of a driving, bit that is equipped with the driving and holding device of the present invention. A screw is shown being retained in an aligned position by the shank attachment device of the present invention.

FIG. 3 is a longitudinal cross sectional view of the holding and aligning device mounted on a screw-driving shaft such as the one shown in FIG. 2. The holding, locking and aligning device is mounted on the shaft of a screw-driving bit that fits into the chuck of an electrically powered drill. A screw is shown in phantom lines in a position to be inserted into the mouth of the locking device.

FIG. 4 is a similar cross sectional view to that of FIG. 3 showing the screw in a position where the head of the screw is camming the tumbler balls out of the way as the head is directed toward engagement with the screw driving bit.

FIG. 5 is a similar view to that of FIG. 4 except that the screw head is fully engaged with the driving bit and abutted against the retaining shoulder of the base member. The tumbler balls are shown to be in the locking positions and the outer locking sleeve is shown in its forward locking position, forcing the tumblers to move radially inwardly against the underside of the screw head to carry out the locking of the screw into an aligned position for the driving operation. The screw tip is shown in position ready to enter the material into which it is to be driven.

FIG. 6 is a cross sectional view similar to FIG. 5 but illustrating the position of the device's component parts during that portion of the screw driving sequence where the screw has been driven far enough into the material so that the outer or distal end of the locking sleeve has contacted the material and the pressure of the material on the distal end of the slidable outer sleeve, with continued driving of the screw, results in retraction of the sleeve and withdrawal of the locking tumblers, effecting a release of the screw head.

FIG. 7 illustrates the last step in the screw-driving sequence where continued driving pressure on the driving shaft has caused the driving bit to slide forwardly within the tubular center of the base member in order to seat the screw within the material.

FIG. 8 is a side view of the driving and locking device as it would appear when driving a screw into material at an angle.

FIG. 9 is a cross sectional view taken along lines 9-9 in FIG. 1.

### DETAILED DESCRIPTION OF THE INVENTION

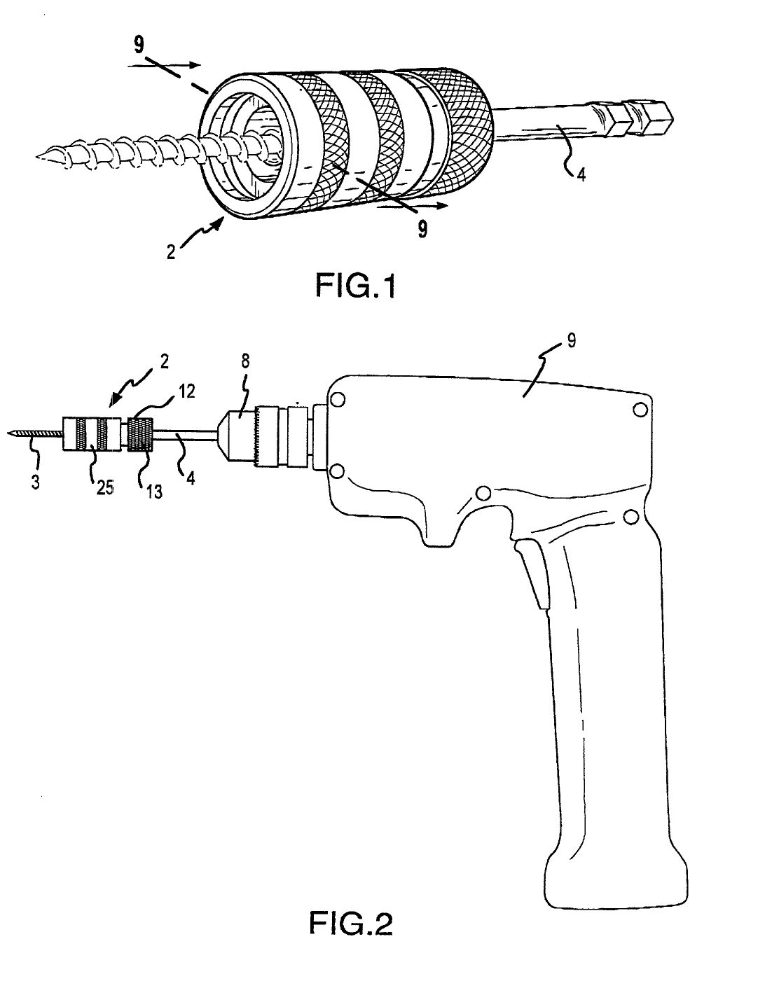

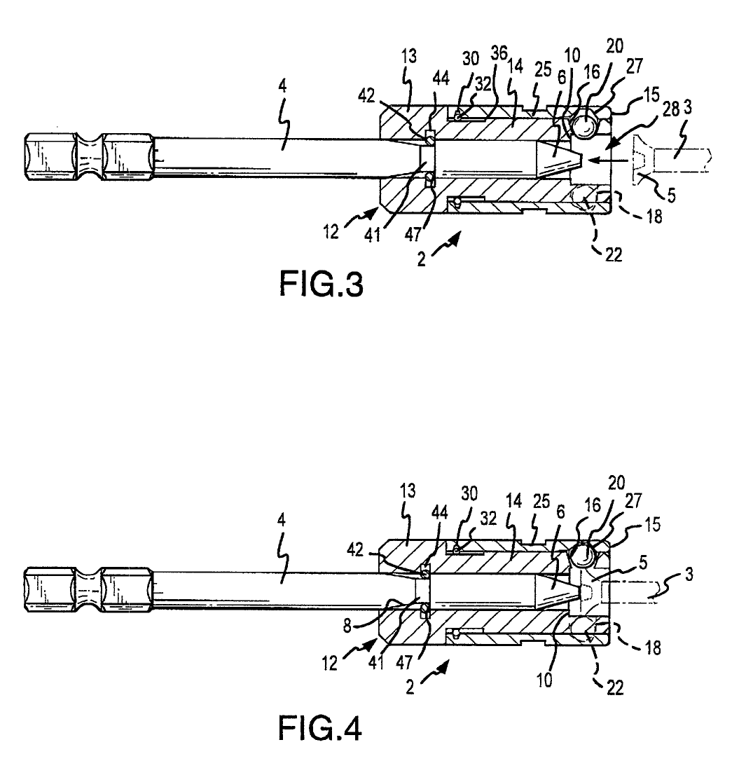

Referring first to FIGS. 1 and 2, the shaft 4 of a screw-driving bit 6 is of the type to be mounted in the chuck 8 of an electrically powered hand held drilling tool 9. Referring to FIGS. 3-7, the locking and aligning device comprises a cylindrical tubular base 12 that is sized and dimensioned for being slidably mounted on the shaft 4 of a screw-driving bit 6. The base 12 comprises a larger diameter proximal end 13 with the remaining and longer portion 14 of the base having a reduced diameter. The distal end 15 of the reduced diameter portion 14 is penetrated by a plurality of radially equally spaced apart bores 16, 17 and 18 (see FIG. 9). Each of the bores functions as a pocket to retain a respective one of several locking or tumbler means, such as the ball bearings 20, 21 and 22 that are illustrated in the drawings of the preferred form of the invention. The bores are slightly conical. That is, the diameter of each bore at its intersection with the inside surface of the reduced diameter portion 14 of the base member 12 is slightly smaller than the diameter of the bore at its intersection with the outside surface of the reduced diameter portion 14 of the cylindrical base 12. Moreover, the diameter of the bore at the inside surface of the reduced diameter portion 14 is slightly less than the diameter of the ball bearing that is pocketed within the bore. This reduced diameter at the inside surface of the tubular base member prevents the ball bearing housed therein from falling through the bore. The larger diameter at the top of the bore, coincident with the outside cylindrical surface of the reduced diameter portion of the base member, allows the ball bearing to move up and down in the bore without restriction. While small metal spheres, such as the ball bearings 20, 21 and 22, are shown in the preferred embodiment, other types of tumbler devices may be used, including keys, pegs, pins or any other kind or shape of device that can perform the locking and unlocking functions that are hereinafter described for the ball bearings 20, 21 and 22.

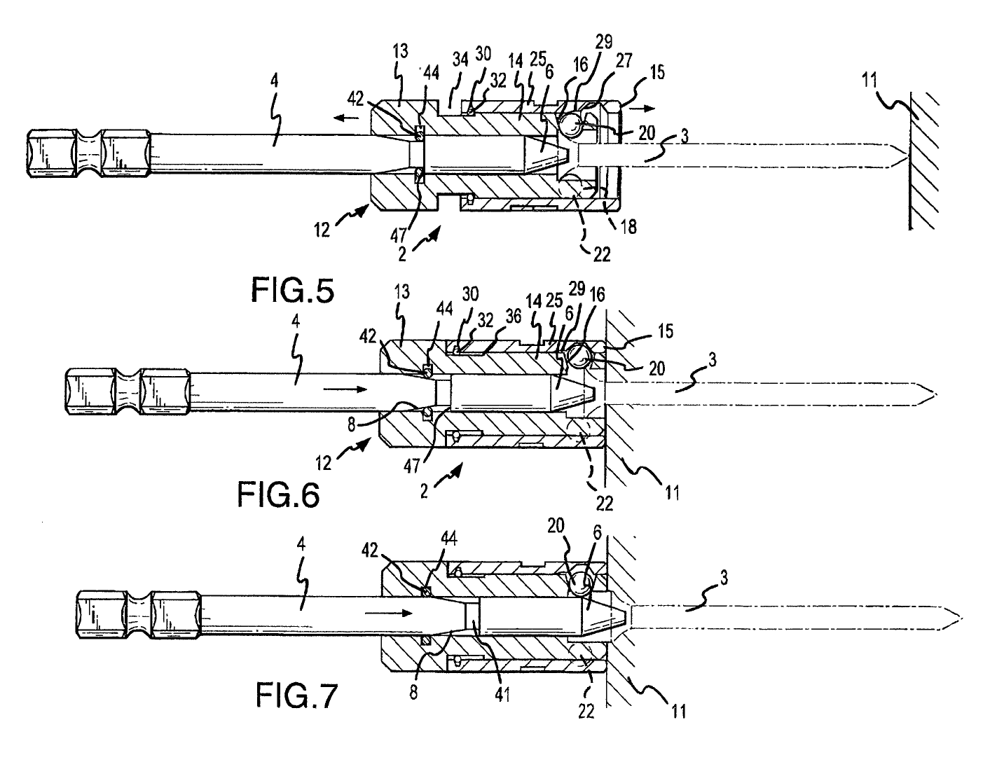

Coaxially mounted around the reduced diameter portion 14 of the base member 12 is a tubular locking sleeve 25. The sleeve is slidable on the reduced diameter portion 14 of the base member 12 from a first screw-receiving position (FIGS. 3 and 4) to a second screw-locking position, shown in FIG. 5. The function of the locking sleeve is performed by several structural components of the sleeve working in cooperation with the tumblers and the base member. First, an annular groove 27, disposed on the inside surface of the distal end of the outer sleeve 25, provides a recess for receiving the ball bearings 20, 21 and 22 when the sleeve is in the retracted screw-receiving and un-locked position. In this position one or two of the ball bearings, such as balls 21 and 22 may simply fall into the grove 27 by the force of gravity, as seen in FIG. 3. If a ball is in an upper circumferential position, gravity pulls it into a dependent position, as seen with the ball 20 in FIG. 3. As a screw 3, having a head 5, is placed into the mouth 28 (FIG. 3) of the sleeve, the head of the screw momentarily cams a depending ball 20 up into the channel 27, as shown in FIG. 4.

When the upper surface of the head 5 of the screw 3 is positioned against the shoulder 10 of the base member 12, the driver bit 6 is seated in the slot or other bit receptacle in the screw head. Following the positioning of the screw against the shoulder 10 of the base member, the sleeve 25 is manually slid forwardly on the small diameter portion 14 of the base member 12, to an extended, or locking position, as shown in FIG. 5. “Forwardly” means toward the direction of the tip of the screw that has been inserted into the mouth 28 of the holding attachment 2. From the force of such forward movement, an inclined annular surface 29 (FIG. 5), adjacent the rear edge of the annular recess 27, contacts the tumbler ball bearings 20, 21 and 22, camming them radially toward the axis of the sleeve 25 and into a position where all of the balls are partially depending from their respective housing bores, as shown in FIG. 5. Complete forward movement of the sleeve 25 positions a portion of the cylindrical inside surface of the sleeve over each of the ball bearing tumblers, preventing upward movement within their respective housing bores and maintaining them in their screw-locking, dependent positions on the underside of the head of the screw 3. With the three ball bearings being equally spaced around the underside of the screw head, and the top of the screw head being abutted against the interior shoulder 10 of the base member, the screw is locked into a position where the longitudinal axis of the screw is aligned with the axis of the screw-driving shaft 4.

To prevent the sleeve 25 from being advanced past its locking position, a shoulder stop 36 (FIG. 6) is provided to arrest the forward movement of the sleeve. An annular groove 30 disposed on the inside surface of the proximal end of the slidable outer sleeve 25 houses a retainer ring 32. The ring moves with movement of the sleeve and within a space 34 provided by a reduced diameter portion on the outside surface 14 of the base member 12. This space 34 terminates in an annular shoulder 36 on the forward end of the reduced diameter portion, against which the retainer ring 32 abuts when the sleeve 25 is advanced to its full forward, extended or screw-locking, position.

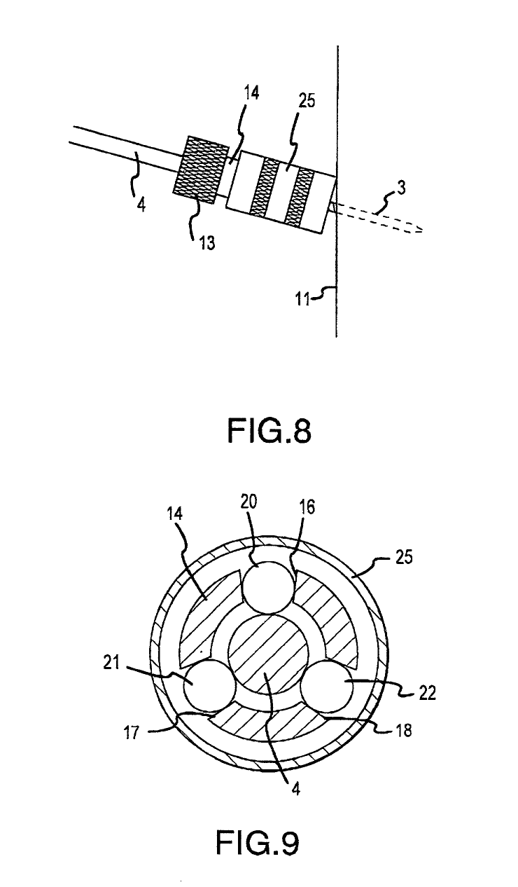

Thus, with the screw locked in an aligned position, the craftsman may use the driving drill 9 alone to aim the screw with accuracy, placing its tip precisely on the target. If an angular drive is necessary, the screw may be positioned at the desired angle with the screw's tip on the target point, without assistance from a source other than the hand held driving drill, as shown in FIG. 8. Without misaligning the screw 3, significant pressure may be applied to the driving tool 9 to assist the screw in making an initial penetration of the material 11 into which it is to be driven. Pressure on the screw will not adversely affect the locking of the screw or the screw's alignment because the screw is securely held in place between the shoulder 10 and the radially spaced locking tumblers 20, 21 and 22 positioned on the underside of the screw head 5.

In order that the driving bit 6 is properly positioned to receive the screw head, relative to the shoulder 10, it is desirable to provide a fixed position on the driver shaft 4 where the screw holding attachment 2 may be readily positioned when it is to be used. For this purpose, the driver shaft 4 is provided with an annular detent 41 having an inclined edge 8 on the proximal side thereof and a perpendicular shoulder 47 on the forward or distal side edge thereof. The inclined edge 8 sloops upwardly from the bottom of the detent 41 toward the cylindrical surface of the shank 4. The annular detent 41 cooperates with an expansible snap ring 42 that is partially disposed in an annular retaining channel 44 located on the inside surface of the proximal end portion of the base member 12. The channel 44 is located in the base member so as to seat the snap ring 42 in the shank detent 41 and against the forward shoulder 47 of the detent when the head of the screw 3 is abutted against the base shoulder 10 and the driver bit 6 is in position to properly engage the slot, slots or other bit receiving receptacle in the screw head 5. See FIGS. 3-5. In that position the screw head will be located so that when the sleeve 25 is moved forwardly the locking tumblers will be forced beneath the head of the screw, as shown in FIG. 5.

A second and very important feature of the positioning detent 41 and the cooperating snap ring 42 is to provide a means for firmly locking the head of the screw to the bit 6, in order to prevent the bit from coming out of the screw head slot, either before or during the driving operation. With the snap ring 42 butted against the shoulder 47 and the screw locked into position by the tumblers, the shaft 4 cannot be disengaged from the screw. This restriction against rearward or proximal movement of the driver shaft 4 with respect to the locked-in screw prevents the driver bit 6 from being pulled, or otherwise forced, out of its engagement with the slot or slots in the screw head. This aspect of the locking mechanism prevents chattering and destructive contact between a partially disengaged screw head and the driver bit, an event that erodes the screw head and dulls the bit.

Following the locking of the screw, the driving operation is begun. As the screw 3 proceeds into the material 11, the distal end 15 of the sleeve 25 approaches and finally abuts the material, as shown in FIG. 6. Continued operation of the screw-driving device 9 causes the driving bit shaft 4 to continue its longitudinal driving motion to seat the screw 3, resulting in pressure on the end of the sleeve by the material and relative motion between the base member 12 and the sleeve 25 that acts to retract the sleeve to the unlocked position shown in FIG. 6. Full retraction of the sleeve displaces the inner surface of the sleeve from a position where it restricts upward movement of the tumblers 20, 21 and 22 to a position where the tumblers may retract into the annular recess 27. In effect, this movement of the sleeve releases the locking pressure on the ball bearing tumblers. Once the sleeve 25 has been retracted by the force of the material 11, completion of the seating of the screw is possible. As the driving shaft is forced toward the material 1 the expansible snap ring 42 located in the positioning detent 41 slides up the proximal inclined slope 8 of the detent expanding into the annular groove 44, as shown in FIG. 6. This expansive action of the snap ring allows the driving shaft 4 to continue its forward motion toward the material 11 so that the screw can be completely driven into and fully seated in the material, as shown in FIG. 7. The tumblers 20, 21 and 22 having been released from their dependent locking positions, the driving bit 6 is freely removed from the head of the screw at the completion of the operation.

For the next operation, the base member 12 is again repositioned on the shaft 4 with the aid of the positioning snap ring 42 and the shoulder 47 of the shaft's detent 41, ready to receive the next screw.

I claim:

1. Screw locking and aligning apparatus for a screw driving device having a shank with a screw driving bit disposed on the one end thereof, comprising:
an tubular base member sized and dimensioned to be slidably mounted on the shank and to encompass the driving bit, said base member having a circumferential wall with inside and outside surfaces, and adapted to receive the head of a screw within the base member for engagement with the driving bit;
at least one opening in the base member wall,
tumblers disposed in the at least one opening and extendable beyond the inside surface of the base member wall toward the longitudinal axis of the base member to engage the head of the screw and thereby retain the screw within the base member and in a position of alignment with the longitudinal axis of the shank,
means limiting the extendable travel of the tumblers,
an outer sleeve having a circumferential wall with inside and outside surfaces and slidably mounted on the outside wall surface of the base member, said inside surface of the sleeve adapted to engage and maintain the tumblers in their extended positions,
a recess disposed on the inside surface of the outer sleeve to receive the tumblers when retracted from their position of engagement with the screw head.

2. Apparatus for locking a screw having a head to a screw-driving bit, comprising,
a screw-driving shaft having a distal end portion containing a driving bit,
stop means disposed on the screw-driving shaft,
a locking attachment mounted on the shaft for receiving at least the head of a screw and carrying movable tumblers positioned to engage the head of the screw,
selectively operable locking means carried by the attachment for driving the tumblers into locking engagement with the screw to thereby restrict longitudinal movement thereof and retain the screw within the attachment,
abutting means carried by the attachment and disposed to engage the stop means, whereby the screw-driving bit is secured in its engagement with the screw head when the locking means is selectively positioned to drive the tumblers into engagement with the head of the screw.

3. Screw locking and aligning apparatus adapted to be mounted on the shank of a screw-driving tool, which shank includes a driving bit to engage the slot, slots or other bit-receiving device in the head of the screw, the apparatus comprising:
locking and aligning means for receiving at least the head of a screw and carrying movable tumblers positioned to engage the head of the screw, and
a selectively operable latch carried by the apparatus for forcing the tumblers into locking engagement with the screw and for aligning the screw with the axis of rotation of the shank of the driving tool.

4. The apparatus of claim 3 where the screw-driving shank includes,
an annular detent depressed below the surface of the shank and located intermediate the first and second ends of the shank, including stop means disposed on the side of the detent closest to the second end of the shank,
abutting means carried by the attachment and disposed to engage the stop means at a selected position of the attachment on the shank, whereby, at said selected position the screw-driving bit is secured in its engagement with the screw head when the locking means is selectively positioned to drive the tumblers into engagement with the head of the screw.

5. The apparatus of claim 4 where the detent includes,
an inclined flank, sloping from the detent to the surface of the shank, disposed on side of the shank closest to the first end of the shank.

6. The apparatus of claim 3 where the locking latch is selectively operable between a retracted non-locking position and an extended locking position.

7. The apparatus of claim 6 where the locking latch is positioned, relative to the locking and aligning attachment, to contact the material at a selected depth of the screw within the material into which it is being driven.

8. The apparatus of claim 7 where the locking latch is retractable into the non-locking position upon application of force there against by the material in contact with the locking latch.

9. The apparatus of claim 8 and further including,
an annular detent depressed below the surface of the shank and located intermediate the first and second ends of the shank,
a stop means-forming shoulder disposed on the side of the detent closest to the second end of the shank,
an inclined edge, sloping from the detent to the surface of the shank, disposed on side of the shank closest to the first end of the shank, and
abutting means carried by the attachment and disposed in the detent to engage the shoulder at a selected position of the attachment on the shank.
